(19) United States
(12) Patent Application Publication
(10) Pub. No.: US 2003/0003205 A1
(43) Pub. Date: Jan. 2, 2003

(54) Fresh meat package

(76) Inventor: Anthony William Costello, Tauranga (NZ)

Correspondence Address: YOUNG & THOMPSON, 745 SOUTH 23RD STREET 2ND FLOOR, ARLINGTON, VA, 22202

(21) Appl. No.: 10/163,466

(22) Filed: Jun. 7, 2002

(30) Foreign Application Priority Data
Jun. 7, 2001 (NZ) 512229
Sep. 7, 2001 (NZ) 514065
Nov. 19, 2001 (NZ) 515548

(51) Int. Cl. A23B 4/00

(52) U.S. Cl. 426/396

(57) ABSTRACT

A package for meat products includes a tray which has walls having at least one layer. The layer is provided with an inner surface and an outer surface. The inner surface is for the placement of a product. The walls are made up of a base portion and side portions. The tray has a cover attached thereto. The tray has at least one venting means.

### TECHNICAL FIELD

The present invention relates to improvements in trays for fresh meat packaging, and in particular to an improved vented tray and a method of packaging fresh meat in the vented tray which provides for a prolonged shelf life.

### BACKGROUND OF THE INVENTION

Fresh meat products are processed into various cuts at the meat processing plant where they are then packaged prior to sending to the retail market. The packaging step includes placing the cuts of meat within a tray which is then over wrapped with a non-barrier clear plastic film. The over wrapped trays are then placed within a vacuum pack and gas-flushed barrier bag.

It is known in the art to package fresh meat in a modified atmosphere environment whereby the packaging is flushed with a preservation-enhancing gas mixture such as carbon-dioxide. In U.S. Pat. Nos. 5,667,827 and 5,711,978 both issued to Breen et al., disclose a process of packaging fresh meat and a fresh meat packaging which provide an inexpensive, retail case-ready packaging for perishable products, such as fresh meat. The prolonged shelf life for the packaged meat products ranges from about 40 to 90 days after which the meat still blooms up to a desired fiery red colour upon exposure of the packaged meat product to oxygen. The invention described in these two U S patents relates to a tray being over wrapped to provide a first and a second enclosed region, a first perforation means disposed along upper portions of said tray allows for gas exchange between said first and second enclosed regions without clogging due to run off juices from the meat or due to shifting of the meat within the tray; and a second perforation means disposed in the plastic wrapping material to permit gas exchange between said second enclosed region and a region outside of said over-wrapped tray.

The present invention provides a unique lidded tray made of any material that can be easily vented.

### OBJECT OF THE INVENTION

It is therefore an object of the present invention to provide an improved fresh meat packaging or vented tray and method of packaging which will obviate or minimize the foregoing disadvantages in a simple yet effective manner or which will at least provide the public with a useful choice.

### STATEMENT OF THE INVENTION

Accordingly in a first aspect the invention consists of a package, the package including a tray being provided with walls having at least one layer which is provided with an inner surface and an outer surface, the inner surface being for the placement of a product, the walls being made up of a base portion and side portions wherein the tray has at least one venting means wherein the tray has a cover attached thereto.

Preferably the cover is a plastics material.

Preferably the plastics material is hermetically sealed to the top of the side portions.

Preferably the product is fresh meat.

Preferably the venting means is an elongate member.

Preferably the venting means is a chimney member.

Preferably the venting means extends from the base portion.

Preferably the venting means is hollow with an aperture at an upper end thereof.

Alternatively the venting means includes at least one micro perforation in the tray.

Preferably the micro perforation(s) are in the side portions of the tray.

Alternatively the venting means includes at least one recess in the side wall portion.

Preferably the recess is in the top of the side portion.

Preferably the tray has a lip portion at the top of the side portions.

Preferably the tray is substantially rectangular in shape having corners.

Preferably the chimney is located in at least one corner.

Preferably the tray has a second layer, which layer nests with the first layer to create an enclosed space there between.

Preferably the second layer has at least one elongate means that interfits with the venting means of the first layer.

Preferably the second layer lies underneath the first layer.

Preferably the second layer is spot welded to the first layer.

Preferably the enclosed space is made up of a closed portion and an open portion.

Preferably the closed portion is in the base portion.

Preferably the closed portion can be used to collect product juices or leakage.

Preferably the tray comprises a closed cell material.

Alternatively the tray comprises a solid material

Preferably the tray comprises a plastics material.

Alternatively the tray comprises an open celled material to absorb any product juices.

Preferably the tray comprises a foamaceous material.

Preferably the walls of the tray are corrugated.

Preferably the corrugations have at least one entry aperture for the meat juices and are hollow for the holding of meat juices.

In another aspect the invention consists in a method of packaging meat, the method includes the following steps:

a) providing a vented tray with a meat product therein.

b) sealing a cover or lid to the tray;

c) placing at least one covered trayed product in a oxygen barrier container;

d) removing oxygen and gas flushing and;

e) sealing oxygen barrier container.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

### BRIEF DESCRIPTION OF THE DRAWINGS

The present invention will be further described with reference to the attached drawings in which,

FIG. 1 shows a section view of top of the tray.

FIG. 2 shows a section view of the top and base of the tray.

FIG. 3 shows a top perspective view of the tray.

FIG. 4 is a bottom perspective of the underneath of the tray.

FIG. 5 shows a perspective view of both layers not joined.

FIG. 6 is a cross section showing the two layers joined.

FIG. 7 is a cross section showing an alternative tray.

FIG. 8 is a cross section showing an alternative tray.

FIG. 9 is a perspective view of the inside of part of the single layer tray.

FIG. 10 is a cross-sectional view of part of the single layer tray.

### DESCRIPTION OF THE PREFERRED EMBODIMENTS

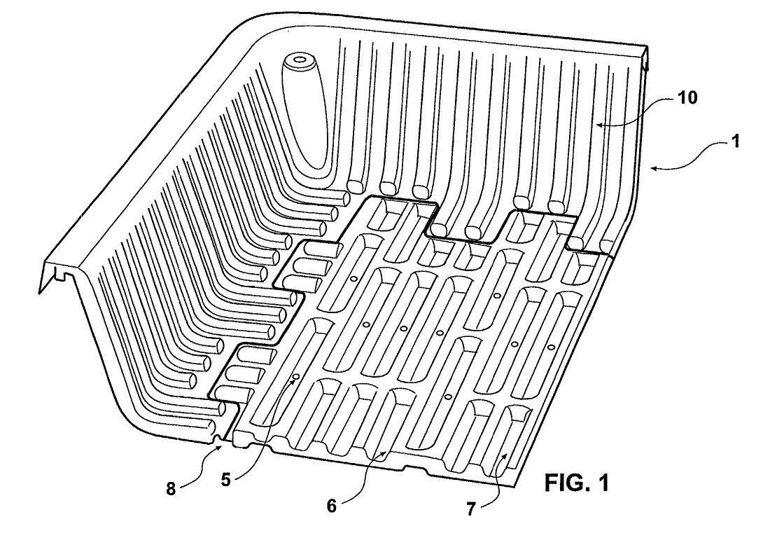

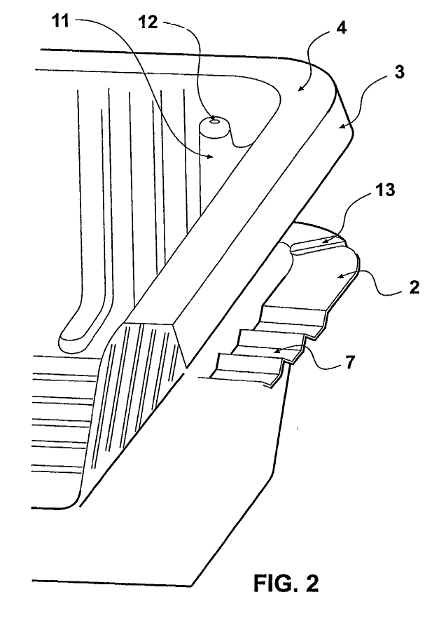

The tray generally indicated as 1 is made up of two layers, a base layer 2 and a top layer 3. These two layers 2 and 3 are formed and joined together to produce a strong tray using minimum material. Preferred materials of construction for the tray would include but are not limited to thermoplastic such as polyvinyl and polystyrene. An outwardly protruding lip 4 is formed along the side and end walls of the top layer 3. The top layer 3 is provided with vent holes 5 preferably placed in the bottom of each channel or corrugations 6 which is formed in the base of layer 3. These vent holes allow the juices from the meat to flow into the channels 7 which are formed when the base layer 2 and top layer 3 are brought together to form the tray 1. The channels 7 can hold a food grade absorbent. The vent holes 5 also allow the removal of air from the channel 7 when the tray is placed in a vacuum. The channel 7 are sealed around the perimeter of the base of the tray 1 as shown in FIG. 1 at 8. The sealing of the channel 7 at point 8, isolates the channel 7 which can then hold the meat juices from the channels 10 which are in the sides of the tray 1. The channels 10 enable the side walls of the tray to vent when placed under a vacuum. In each corner of layer 3 a protrusion 11 is formed. In the top of this protrusion 11 a hole 12 is placed. In each corner of base layer 2 a slot 13 is formed. The hole 12 and the slot 13 enable the inside of the tray to be vented when a lid is sealed onto the lip 4.

A lid such as a web of clear plastic wrapping material is heat sealed around the lip 4.

It can be seen from the above description that the tray of the present invention is not over wrapped, rather it is lidded. The tray of the present invention can easily be evacuated when the tray is used in known case-ready packaging.

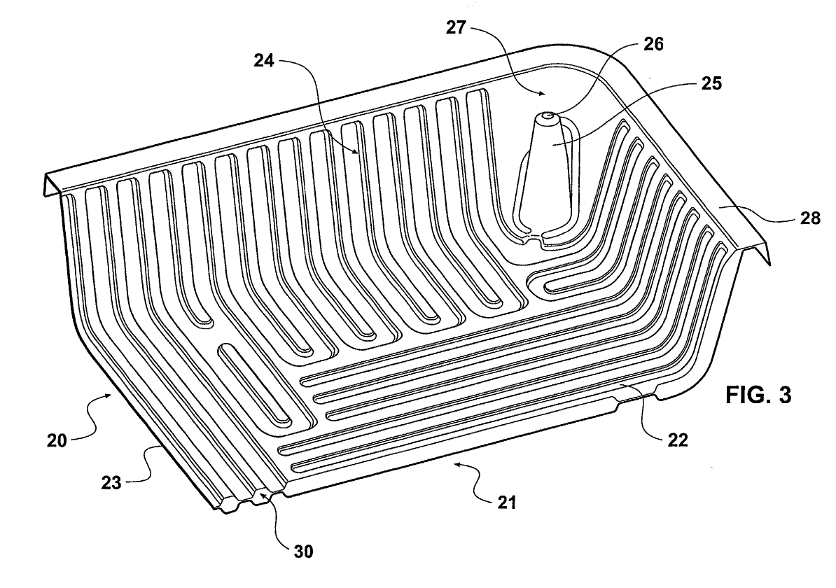

The packaging system includes a tray 20 as shown in FIG. 3 which is made up of at least one layer 21. Layer 21 has an inner surface 22 and an outer surface not shown. The inner surface is made up of a base portion 23 and side portions 24. Layer 21 can be grooved, corrugated or wavy shaped. The tray has at least one corner 27 there being at least one elongate member 25, which is preferably, chimney shaped with an aperture 26 at the upper most end. The elongate member is preferably hollow and moulded within the shape of the layer 21. Layer 21 also has a lip L, which is made up of a flat portion 28 and a vertical portion 29. Layer 21 has ribs 30, which can be any shape but are preferably formed from the layer itself by deformation.

FIG. 4 is a view of a second or bottom layer 21 of the tray looking from underneath. This shows the outer surface 31 having a base portion 32 and side portions 33. Layer 21 can be grooved, corrugated or wavy shaped.

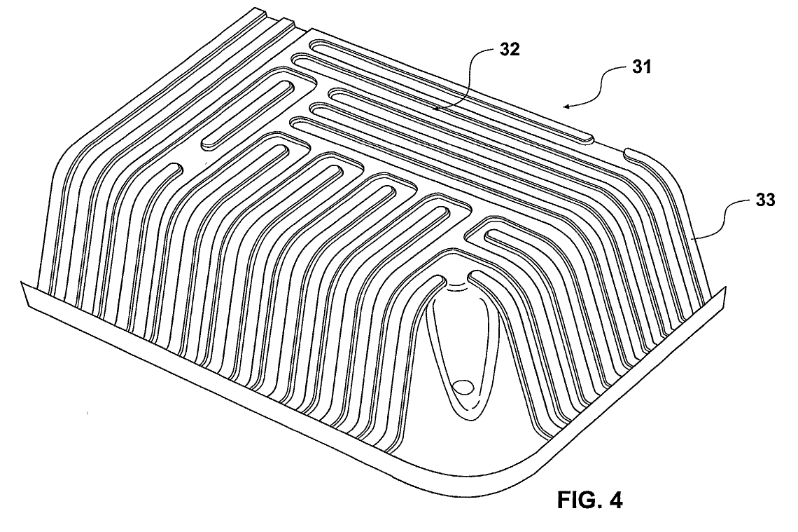

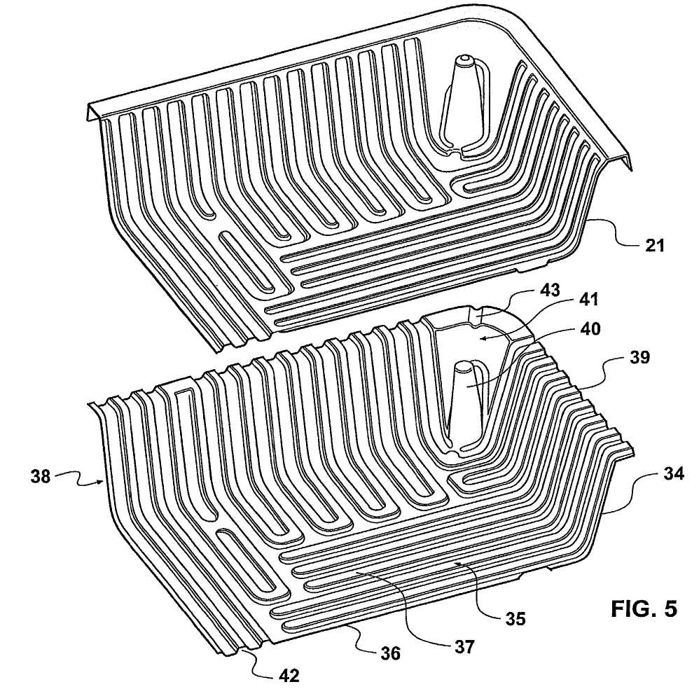

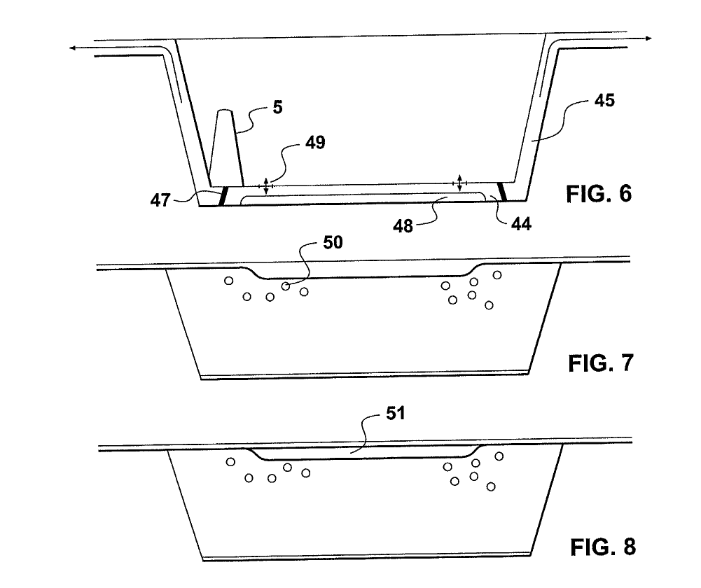

As shown in FIG. 5 there is a second layer 34, which nests and joins with layer 21. Layer 34 is preferably situated underneath layer 21. Layer 34 also has an inner surface 35 which is made up of a base portion 36 and side portions 38. Layer 34 has a lip 39 and corners 41. Within corner 41 it is preferred that there is a slender member 40 which matches or is similar in shape to the elongate member 25 of top layer 21 so that when the two layers 21 and 34 are nested, they inter-fit therein to create a space therebetween the layers. As shown in FIG. 6 the space can be made up of an closed portion or enclosed portion 44 and an open portion or a side portion 45 which can be drained or evacuated through channel 43. The enclosed space 44 is made up by welding or joining the two layers in a line 47 that borders the base portion. This space can be used to contain any product leakage or product juices. A soaker pad 48 can be used in combination to also soak up any product juices. The space 45 outside this weld line comprises mainly a space adjoining the side portions of the tray. This side portion 45 space is open at the upper end and can evacuated when evacuation occurs. Layer 34 has a series of ribs or corrugations 42 that are moulded within the surface, which are similar to the ribs 30 of layer 21. These ribs serve to provide a strengthening means and a means of enabling the juices to be drained or directed away. To enter the enclosed space the juices through an aperture means 49 in the first layer 21.

Layer 34 can have channels in the lip to facilitate evacuation. The trays can be made of any suitable material however some examples that are preferred are open celled materials, closed cell materials or solid material such as plastics. The figures show the tray being rectangular in shape. Any shape that suits the product, is envisaged.

In use, layer 34 is nested and joined, with layer 21 which are joined together to create an enclosed space therebetween and or to strengthen the tray. The joining can be by spot welding. After which, a lid or cover (not shown) is attached to the top layer 21. Preferably the lid is hermetically sealed to the tray. The lid is attached to the lip portion of layer 1 and the lid may comprise generally of a clear plastics wrapping material. This material is heat sealed around the lip after which, the tray made up of the two layers and the lidded portion, can then be evacuated and then sealed in an appropriate manner e.g. in an oxygen resistant barrier bag. Evacuation is used to help preserve the stored product and extend its shelf life.

In combination with the double layered tray or as an alternative, in FIG. 7 the tray can have at least one micro perforation 50 in the walls to also assist in venting when the tray and lid assembly is evacuated. The perforations 50 are too small to allow juices etc to exit. Yet another alternative for the tray or in combination with, is shown in FIG. 8. Here the tray can have a recessed portion 51 in the upper portion of the sidewall. This recess 51 can be at least one ‘micro slit’ and provides a gap bordered by the lid that may be attached to the tray.

The packaging system includes a cover or ‘lid’ which can be sealed e.g. with plastics sheeting hermetically sealed. The covering of plastics is preferably sealed to the lip and not overwraped. Overwrapping though may occur unintentionally. This cover can be leakproof i.e. juices can not leak out. It is preferred that the cover has no perforations or apertures.

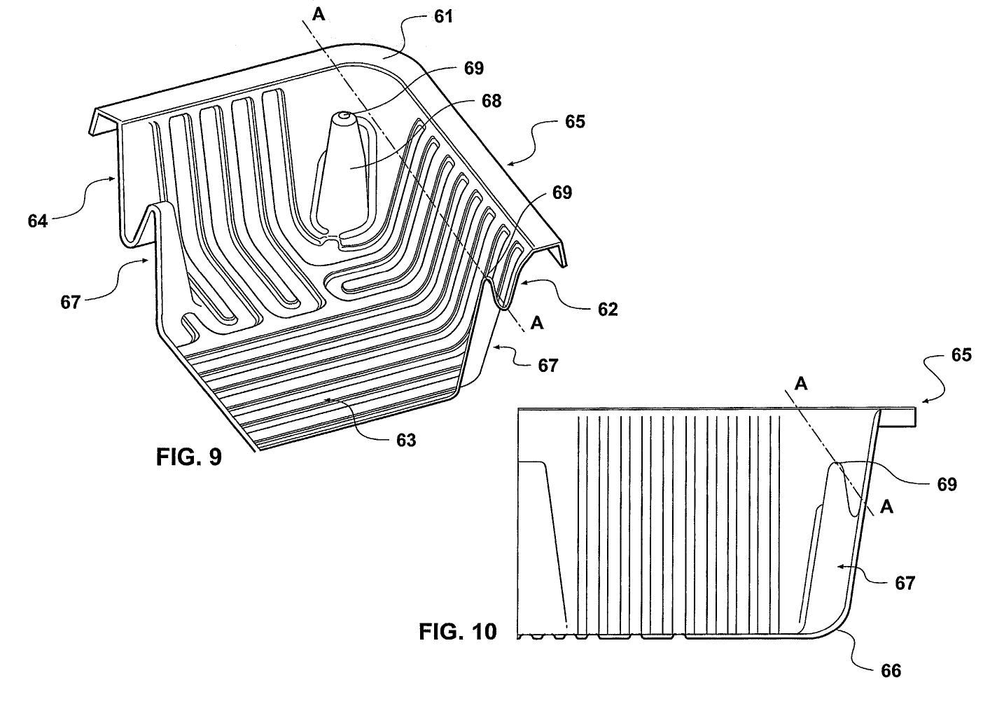

As shown in FIGS. 9 and 10 a single layer tray 60 which can be used in a modified or controlled atmosphere has an inner surface 61 and an outer surface 62. The tray can be any shape that fits the product to be housed and or the volume of exudate to be produced or fits the display means or fits the method of atmospheric control used. In a modified or controlled atmosphere, the tray can be sealed with a cover or lid member which may then be contained in a further barrier means or barrier container. The tray layer can be grooved or corrugated or wavy shaped. The barrier container can be an oxygen barrier bag. In further processing the bagged trayed product may be vented to remove and modify unwanted gaseous atmosphere. The tray has a base portion 63 and side portion 64. The tray may also have a lip portion 65 and corner portions 66.

At least one venting means 67 and or 68 is provided anywhere on the inner surface 61 or outer surface of the tray. The venting means can be sited on the lip portion 65 or the base 63 or the sides 63.

The venting means 67 or 68 can be of any shape such that venting can occur. It is preferred that the venting means includes a protuberance or extension member of any shape, from the inner surface 61 of the tray, having at least one aperture 69. The extension member has a surface. The extension member can be chimney shaped, mountain shaped, peaked or flattened peak, elongate hill shaped or ridged shaped depending on the size of tray and product coupled with customer requirements etc. The extension member can also extend around part of the tray surface or even substantially circumferentially on the surface. The extension member can a separate member to the tray surface being supported therefrom or it may be integrally formed therewith or it may folded or deformed from the tray surface.

The aperture 69 can be any size or shape, it can be circular or it can be slitted or slotted. The aperture 69 can be flapped or small enough to allow automatic opening when under pressure during both or each of processing or display. The aperture 69 may be, further recessed or protruding from the surface of the extension member.

The venting means can be sited in the corners of the tray in the centre of the tray, to achieve maximum volume captivity of the exudate. There can be at least one venting means or there may be several and or they may be in a pattern formation in the tray.

When the tray is sealed, e.g. with a plastics cover, it is preferred that the protuberance or extension member which has at least one aperture therein, can allow venting there through and not leakage of exudate. The aperture is preferably shaped in size and in a number according to one preferment to not allow exudate to exit the tray.

It is also preferred that the aperture 69 is sized with respect to the surface tension of the particular type of exudate. The angle of repose (line A-A in FIGS. 1 & 2) of the exudate in the sealed tray or the maximum angle of exudate in the sealed tray when it is tipped, is substantially 450 as shown in the figures. This will keep the exudate within the tray even if it is tipped.

The size of tray and/or size of venting means can be based upon the desired volume of exudate that can be produced for example say 30 ml-35 ml. The extension can also be located on a shelf or ledge which can be positioned anywhere within the tray.

Throughout the description and claims of this specification the word “comprise” and variations of that word, such as “comprises” and “comprising”, are not intended to exclude other additives, components, integers or steps.

The vented tray or packaging and packaging method has the following advantages:

1. Extended shelf life and leakproof when covered or lidded with plastics.

2. Several alternative constructions e.g. double walled, perforated or silt walls.

3. Cheap and easy to manufacture.

4. Pleasing appearance.

What we claim is:

1. A package, the package including a tray being provided with walls having at least one layer which layer is provided with an inner surface and an outer surface, the inner surface being for the placement of a product, the walls being made up of a base portion and side portions, the tray has a cover attached thereto wherein the tray has at least one venting means.

2. A package as claimed in claim 1 wherein the cover is a plastics material.

3. A package as claimed in claim 2 wherein the plastics material is hermetically sealed to the top of the side portions.

4. A package as claimed in claim 3 wherein the product is fresh meat.

5. A package as claimed in claim 4 wherein the venting means is an elongate member.

6. A package as claimed in claim 4 wherein the venting means is a chimney member.

7. A package as claimed in claim 4 wherein the venting means extends from the base portion.

8. A package as claimed in claim 4 wherein the venting means is hollow with an aperture at an upper end thereof.

9. A package as claimed in claim 4 wherein the venting means includes at least one micro perforation in the tray.

10. A package as claimed in claim 9 wherein the micro perforation(s) are in the side portions of the tray.

11. A package as claimed in claim 4 wherein the venting means includes at least one recess in the side wall portion.

12. A package as claimed in claim 11 wherein the recess is in the top of the side portion.

13. A package as claimed in claim 12 wherein the tray has a lip portion at the top of the side portions.

14. A package as claimed in claim 13 wherein the tray is substantially rectangular in shape having corners.

15. A package as claimed in claim 14 wherein the chimney is located in at least one corner.

16. A package as claimed in claim 15 wherein the tray has a second layer, which layer nests with the first layer to create an enclosed space there between.

17. A package as claimed in claim 16 wherein the second layer has at least one elongate means that interfits with the venting means of the first layer.

18. A package as claimed in claim 17 wherein the second layer lies underneath the first layer.

19. A package as claimed in claim 18 wherein the second layer is spot welded to the first layer.

20. A package as claimed in claim 19 wherein the enclosed space is made up of a closed portion and an open portion.

21. A package as claimed in claim 20 wherein the closed portion is in the base portion.

22. A package as claimed in claim 21 wherein the closed portion can be used to collect product juices or leakage.

23. A package as claimed in claim 22 wherein the tray comprises a closed cell material.

24. A package as claimed in claim 22 wherein the tray comprises a solid material

25. A package as claimed in claim 22 wherein the tray comprises a plastics material.

26. A package as claimed in claim 22 wherein the tray comprises an open celled material to absorb any product juices.

27. A package as claimed in claim 26 wherein the tray comprises a foamaceous material.

28. A package as claimed in claim 27 wherein the walls of the tray are corrugated.

29. A package as claimed in claim 28 wherein the corrugations have at least one entry aperture for the meat juices and are hollow for the holding of meat juices.

30. A method of packaging meat, the method includes the following steps:
a) providing a vented tray with a meat product therein.
b) sealing a cover or lid to the trayed product;
c) placing at least one covered trayed product in a oxygen barrier container;
d) removing oxygen and gas flushing and;
e) sealing oxygen barrier container.
